(19) United States
(12) Patent Application Publication
(10) Pub. No.: US 2004/0188538 A1
(43) Pub. Date: Sep. 30, 2004

(54) Application head for applying a liquefied liner to a vessel interior

(76) Inventor: James L. Birdsall, Boonville, CA (US)

Correspondence Address: James L. Birdsall, P.O. Box 1051, Boonville, CA, 95415, US

(21) Appl. No.: 10/813,825

(22) Filed: Mar. 29, 2004

Related U.S. Application Data
(60) Provisional application No. 60/459,453, filed on Mar. 31, 2003.

(51) Int. Cl. B05B 3/02

(52) U.S. Cl. 239/214

(57) ABSTRACT

Two rotating cups are mounted to a motor to rotate in opposite directions in an application head for depositing a liquid coating material on the interior surface of a vessel by remote control. Each rotating cup is constructed with internal baffles in the form of spirals, those of one cup spiraling in the direction opposite those of the other cup, and each spiral terminating in an opening at the cup periphery. The two rotating cups eject streams of the liquid coating material that are at angles to the radii of the cups and that rotate as the cups rotate, the streams from one cup striking the vessel surface from one side of the radius and those from the other cup striking the surface from the other side of the radius.

### BACKGROUND OF THE INVENTION

1. Field of the Invention

This invention resides in the field of liquid handling, and particularly rotating cup-type liquid distribution heads for dispersing or spraying liquids.

2. Description of the Prior Art

The lining of pipes or other vessels by remote access is often required at environmental remediation sites, construction sites and commercial operations. An underground pipe that has cracks or fissures, for example, frequently requires the application of a new lining without exposing or opening the pipe. Structures that may need a new lining but lack direct access include ducts and pipes in buildings, construction sites, bridges, parking structures, building foundations, mines, manholes, underground tanks or reservoirs, undersea vessels, and dams. The types of deterioration and resulting problems that can create the need for a new lining are illustrated by underground pipes for the transport of water, sewage, or drainage. These pipes are susceptible to corrosion, organic growth, root infiltration, traffic loading, ground movement, and general degradation. Forces of these types cause obstructions in the flow through the pipe and in some cases collapse of the pipe. A degraded sewer pipe, for example, may result in the leakage of sewage from the pipe and the contamination of both ground water and soil formations, or it may cause ground water to enter the pipe, increasing the flow to a treatment plant.

To avoid above-ground disruptions when repairing these pipes, repair methods have been developed that do not involve removing the pipe from the ground or digging a trench, but instead consist of applying a lining to the interior wall of the pipe by remote control. In one of these methods, a soft, flexible tubular liner that includes a curable resin is inserted into the pipe. Once inserted, the liner is pressurized with fluid or air to press the liner against the pipe wall where it is allowed to cure. The procedure is an awkward one, since the uncured liner tube cannot be manipulated inside the pipe, and there is less than full assurance that the tube is properly placed or evenly pressurized along its entire length to achieve the desired degree of repair.

In other methods, a long flexible conduit is inserted into the pipe, and a resin is sprayed out through a nozzle at the end of the conduit to coat the inside wall of the pipe. The resin is then cured in place after the spray application. Both single-component and two-component resins such as epoxies, polyurethanes, and polyureas can be applied in this manner.

A goal in lining underground pipes and other vessels by remote access is to achieve a lining of uniform thickness. The nozzle or application head at the terminus of the conduit must therefore be one that distributes the resin evenly along the wall surface of the vessel. Simple spray nozzles and rotary nozzles serve this function adequately when the interior vessel surface is relatively smooth. Rotary nozzles are generally preferred for achieving a uniform deposition around the circumference of the vessel. When the vessel wall contains protrusions or separations such as large fissures, cracks, or misalignments, however, as is often the case when relining is needed, both rotary and non-rotary nozzles tend to deposit more of the resin on one side of the protrusion or separation, leaving the other side either thinly coated or uncoated and therefore vulnerable to stress or leakage.

### SUMMARY OF THE INVENTION

A novel application head has now been devised that deposits a curable liquid coating material or any liquid in general over the inner wall of a vessel in an even distribution produced by angled streams from both sides of the vessel radius, thereby compensating for any surface irregularities that might cause a nonuniform thickness if the liquid streams were either radial or angled from only one side of the radius. The angled streams are produced by two rotating cups, each having one or more internal baffles spiraling outward, each baffle terminating at a port in the peripheral wall of the rotating cup. The baffles in the two cups spiral in alternating directions, and the cups are likewise mounted coaxially for rotation in opposite directions, with the result that liquid fed to the interior of each cup is ejected through the peripheral port(s) at an angle between the tangential and radial directions of the cup. The two rotating cups are arranged so that their ports are unobstructed. The cups are preferably of the same diameter and spaced a short distance apart along their common axis. It is also preferred that each cup has the same number of baffles and peripheral ports and thereby ejects the same number of liquid streams, and that when two or more streams are produced by any single cup, those streams are evenly distributed around the circumference of the cup.

Further preferred embodiments of the invention include a counter-rotating motor that simultaneously turns the two cups in opposite directions, and a branched liquid supply line for delivering the liquid simultaneously to the interiors of the two rotating cups. Still further preferred embodiments and system features will be apparent from the description that follows.

### BRIEF DESCRIPTION OF THE DRAWINGS

FIG. 1 is a side elevation of an application head in accordance with this invention.

FIG. 2 is a cross section of the rear rotating cup of the application head of FIG. 1, taken along the line 2-2 of FIG. 1.

FIG. 3 is a cross section of the forward rotating cup of the application head of FIG. 1, taken along the line 3-3 of FIG. 1.

FIG. 4 is an exploded view of the application head of FIG. 1.

FIG. 5 is a diagram of a trolley on which are mounted the application head of FIG. 1 plus additional components used in applying a coating to the interior surface of a vessel.

### DETAILED DESCRIPTION OF THE INVENTION AND PREFERRED EMBODIMENTS

The rotating cups of this invention have bases that are disks, preferably flat and circular, with central openings either for mounting the disks on a drive shaft or for the passage of conduits such as a liquid supply tube. The baffles on each cup protrude upward from the disk base and spiral outward, the baffle(s) of one cup in the clockwise direction and those of the other in the counter-clockwise direction. The term “spiraling outward” as used herein denotes the shape of a line described by a point that moves around, while continuously receding from, a central point or line, which in this case is the axis of the rotating cup. The term “planar” as used in describing the baffle, and the phrase “spirals in a single plane,” denote that the baffle is formed of a spiral that does not have a helical component, i.e., the curvature itself is not three-dimensional other than the height of the baffle above the flat base of the cup. The spiral baffles of this invention preferably each have less than one full turn around the axis of the cup, more preferably less than a half turn, and most preferably less than a quarter turn. While the application head of this invention will function with rotating cups that contain but a single outwardly spiraling baffle per cup, the number of baffles is preferably two or more per cup, more preferably four or more per cup, and most preferably four to twelve per cup.

While the invention can assume a variety of different shapes, configurations and arrangements, the drawings herewith depict one specific implementation of the concepts and principles of the invention as an illustration.

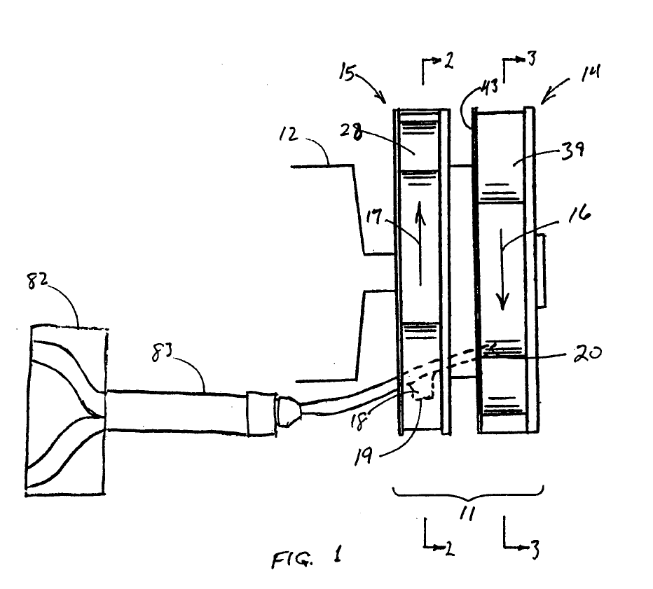

FIG. 1 depicts an application head 11 with a drive motor 12 and a liquid feed line 13. The application head 11 includes a forward rotating cup 14 and a rear rotating cup 15. In this side view, only the outer edges of the two rotating cups are visible, and the arrows 16, 17 indicate that the two cups are rotating in opposite directions. If viewed from the rear, i.e., from the left of the Figure, the forward rotating cup 14 rotates in the counter-clockwise direction while the rear rotating cup 15 rotates in the clockwise direction. The liquid feed line 13 is a single tube with a branch 18 and two openings, one 19 at the branch and the other 20 at the end of the tube. The branch opening 19 discharges liquid into the rear rotating cup 15 and the opening 20 at the tube end discharges liquid into the forward rotating cup 14.

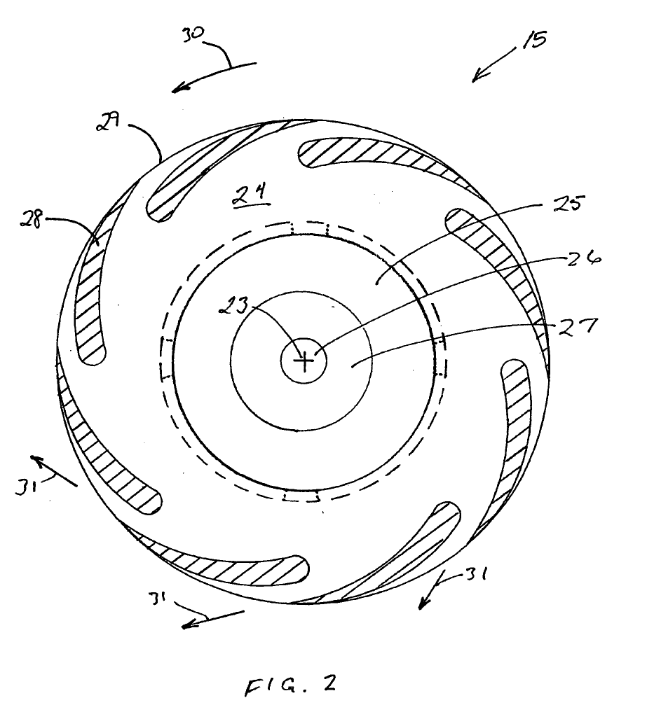

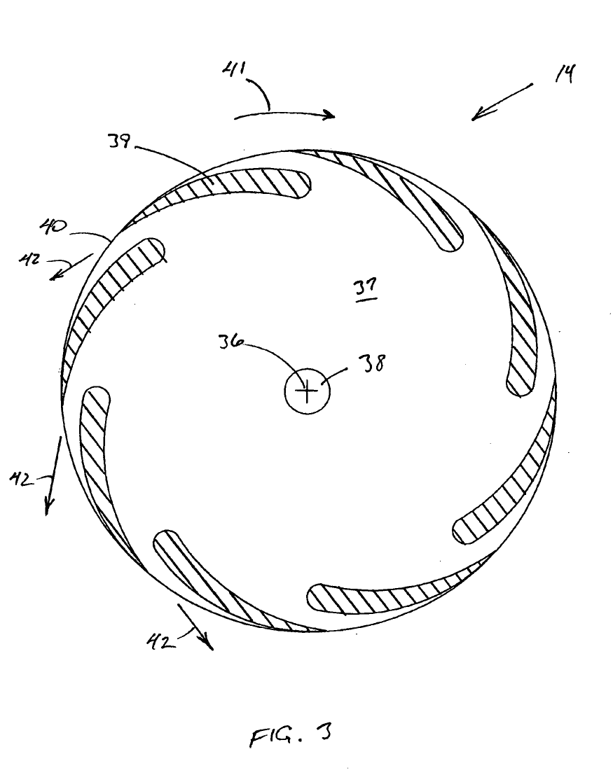

A cross section of the rear rotating cup 15 along the plane 2-2 is presented in FIG. 2, while a cross section of the forward rotating cup 14 along the plane 3-3 is presented in FIG. 3. The rear rotating cup is generally circular about a central axis 23 and includes a flat disk 24 with a central circular well 25 and a circular opening 26 at the center of the well. Surrounding the opening 26 is a boss 27 or short raised cylinder which, as shown in the succeeding Figures and explained below, serves as a platform for securing the cup to one of the motor shafts. Extending rearward (i.e., axially relative to the cup axis 23) from the disk 24 are the baffles 28, each of which spirals outwardly in the clockwise direction by forming an arc that is eccentric with respect to the axis 23 of the rotating cup. Each baffle terminates at its outer end in an opening or port 29 along the outer periphery of the cup. In operation, the cup rotates about its central axis 23 in the direction of the arrow 30 while liquid is fed to the cup interior by the stationary liquid feed tube 13 (FIG. 1) through the branch opening 19 (FIG. 1). The discharge from the feed tube occurs at a location a short distance inward from the baffles 28. As the cup rotates, the incoming feed strikes each of the baffles in succession, and the liquid is ejected through the peripheral ports 29 in multiple streams 31 each of which is at an acute angle to the tangential. The rearward face of the rotating cup is secured to a flat ring 32 (visible in FIG. 1) that covers the baffles 28.

The forward rotating cup 14 as shown in FIG. 3 is also generally circular about a central axis 36 and includes a flat disk 37 with a circular opening 38 at its center and spiral baffles 39 extending rearward (in the axial direction) from the disk, each baffle terminating in an opening 40 at the periphery of the disk 37. The baffles 39 in this forward rotating cup spiral outward in the counter-clockwise direction, the reverse of the direction of the baffles 28 in the rear rotating cup. In operation, the cup rotates about its central axis 26 in the direction of the arrow 41 while liquid is fed to the cup interior by the stationary liquid feed tube 13 (FIG. 1) through the tube end opening 20. The tube is arranged so that the tube end opening 20 is a short distance inward from the baffles 39. As the cup rotates, the incoming feed strikes each of the baffles in succession, and the liquid is ejected through the peripheral ports 40 in multiple streams 42, each of which is at an acute angle to the tangential, the reverse of the acute angle of the streams ejected by the rear rotating cup. The rearward face of the forward rotating cup is secured to a flat ring 43 (visible in FIG. 1) that covers the baffles 39.

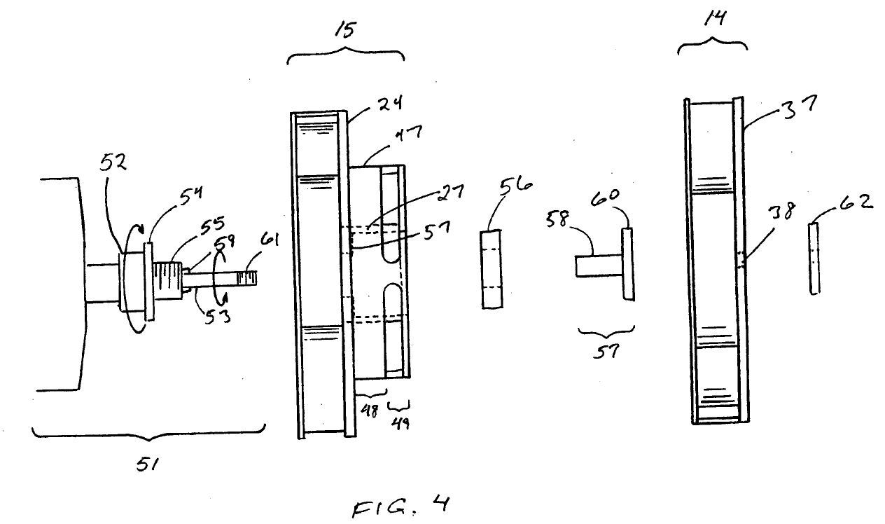

Further features of the rear rotating cup 15 are visible in FIG. 4. The well 25 of the cup as shown in FIG. 2 is formed by a cylindrical extension 47 that includes a solid wall portion 48 that extends directly from the disk 24 (the portion of the extension closest to the disk) and a fenestrated portion 49 adjacent to the solid wall portion (and furthest from the disk). Openings 50 in the fenestrated portion provide access to the interior of the forward rotating cup 14 when the forward rotating cup is positioned over the fenestrated portion 49, as shown in FIG. 1. Thus, the portion of the liquid feed tube 13 (FIG. 1) that extends beyond the branch 18 passes through the solid wall portion 48 (FIG. 4 ) of the rear rotating cup to place the tube end opening 20 (FIG. 1) within the fenestrated wall portion 49, so that the discharge from tube end opening 20 passes through the openings 50 in the fenestrated portion to reach the baffles in the forward rotating cup. The solid wall portion 48 prevents or minimizes stray liquid from leaving the application head by means other than through the two rotating cups.

The motor 51 that drives the two rotating cups is likewise shown in FIG. 4. The motor includes a cylindrical shaft 52 and a rod shaft 53 positioned inside the cylindrical shaft, the two shafts rotating in opposite directions. The cylindrical shaft 52 includes a flange 54 that contacts the rear end of the boss 27 in the center of the rear rotating cup. The forward end 55 of the cylindrical shaft 52 is threaded, and a threaded ring 56 fits inside the boss 27 from the forward end to mate with the threads on the cylindrical shaft and contact the forward face of an inwardly directed flange 57. The rear rotating cup 15 is thus secured to the cylindrical rotating shaft by compression of the boss flange 57 between the flange 54 on the shaft and the ring 56.

A spacer sleeve 57 has a cylindrical portion 58 that fits inside the boss and slides over the rod shaft 53. The rear end of the cylindrical portion 58 of the spacer sleeve rests against a shoulder 59 on the rod shaft and a flange 60 on the spacer sleeve contacts the flat disk 37 of the forward rotating cup, allowing the rod shaft 53 to extend through the central opening 38 in the disk so that the threaded forward end 61 of the rod shaft protrudes from the forward face of the disk. The threads on the protruding end mate with the internal threads of a threaded ring 62. The forward rotating cup 14 is thus secured to the rod shaft 53 by compression of the flat disk 37 between the flange 60 on the spacer sleeve and the forward threaded ring 62.

Counter-rotating motors that can be used to drive the two shafts are readily available from commercial suppliers. Examples are Kollmorgen RBE 01810 brushless DC motors (Kollmorgen, Radford, Va., USA), that are capable of 14,000 rpm and that deliver 0.280 hp at 7,040 rpm. Examples of drives for these motors are MCG BMC 12L brushless servo drives (also available from Kollmorgen). Other examples will be readily apparent to those skilled in the art.

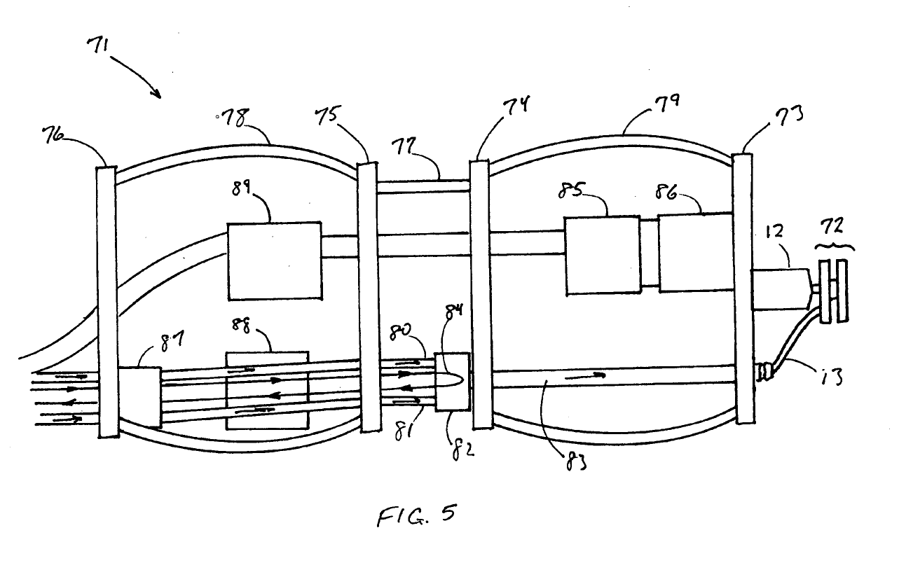

In use, the application head is mounted to the distal end of a trolley that centers the application head in the pipe and serves as a support for the various additional components that are needed to supply the resin and to monitor and control the operation of the application head. An example of such a trolley is shown in FIG. 5. The trolley 71 is shown with the two rotating cups 72 at the distal end, which is at the far right of the figure. At the rear of the rotating cups is the counter-rotating motor 12 and the liquid feed line 13. These and the other components mounted to the trolley are held in place by a series of support plates 73, 74, 75, 76 which are joined by bars (only one of which 77 is shown between the two center plates; others are secured between the remaining pairs of plates) and by curved centering rods 78, 79 whose length and curvature are selected for a particular pipe diameter to position the trolley in the center of the pipe. For two-component resins, the trolley supports two liquid-carrying conduits 80, 81, joins the two conduits at a mixing block 82 into a common stream, and feeds the common stream to a static mixer 83. The mixing block 82 and static mixer 83 are also shown in FIG. 1. The static mixer, also known as a motionless mixer, is a conventional component readily available from commercial suppliers. An example is STATOMIX® ME and MS series plastic disposable mixers, available from ConProTec, Inc., Salem, N.H., USA. Also shown in FIG. 5 is a heating loop 84 within the mixing block 82 for the circulation of a heating medium such as heated water. Other components supported by the trolley include power supplies and controllers 85, 86 for the motor, one for the cylindrical shaft and the other for the rod shaft, valves 87 for the two resin components and the heated water, data acquisition modules 88 for monitoring various aspects of the process such as the temperature of the components and condition of the deposited film, and a power supply 89 for the valves and the data acquisition modules. All electrical and fluid lines are combined in a single multi-lumen cable (commonly referred to in the industry as an “umbilical cable”) extending from above ground to the trolley. In operation, the trolley is pulled backwards through the pipe (toward the left in the view shown in the figure) as the liquid streams are emerging from the application head. The trolley is pulled either manually from above ground or mechanically by an appropriate above-ground drive mechanism. The trolley components and those of the entire system in general are described in co-pending U.S. patent application Ser. No. 10/033,704, filed Oct. 27, 2001, entitled “System and Method for Delivering Reactive Fluids to Remote Application Sites,” which application is incorporated herein by reference in its entirety.

Liquids that can be applied by the application head of this invention include any composition that will serve a purpose on the interior surface of a vessel. Curable resins are of greatest interest, and this invention is useful in applying both single-component compositions and multiple-component compositions, notably compositions that are formed by the reaction of two or more components that react upon contact and must therefore be kept out of contact to prevent premature reaction until they reach the point of application. This description applies to many polymers. Examples are two-component polymer systems including, but not limited to, epoxies, polyurethanes, polyureas, and polyesters. Epoxies are of particular interest, especially for pipe lining applications. For optimum performance, the individual components are maintained at a temperature within a preselected range to control viscosity and maintain a uniform consistency.

The foregoing descriptions are offered primarily for purposes of illustration. Further variations and modifications that still embody the basic elements of this invention will be readily apparent to those skilled in the art and are included within the scope of this invention.

What is claimed is:

1. Apparatus for coating the interior surface of a vessel with a liquid coating material, said apparatus comprising:
a first rotating cup having at least one baffle spiraling outwardly counter-clockwise and terminating at a peripheral port;
a second rotating cup having at least one baffle spiraling outwardly clockwise and terminating at a peripheral port;
means for positioning said first and second rotating cups coaxially with all of said peripheral ports unobstructed, and for simultaneously spinning said first rotating cup counter-clockwise and said second rotating cup clockwise; and
means for delivering said liquid coating material to said first and second rotating cups such that when said first and second rotating cups are spinning said baffles and said peripheral ports cause said liquid coating material to be ejected simultaneously from both said first and second rotating cups.

2. Apparatus in accordance with claim 1 in which each baffle spirals in a single plane.

3. Apparatus in accordance with claim 1 in which said first rotating cup has at least two baffles each terminating at a peripheral port, and said second rotating cup has at least two baffles each terminating at a peripheral port.

4. Apparatus in accordance with claim 1 in which said first rotating cup has from four to twelve baffles each terminating at a peripheral port, and said second rotating cup has from four to twelve baffles each terminating at a peripheral port.

5. Apparatus in accordance with claim 1 in which said first and second rotating cups are of substantially equal diameter and are displaced from each other along said common axis.

6. Apparatus in accordance with claim 1 further comprising:
a cylindrical extension on, and coaxial with, said first rotating cup, said cylindrical extension comprising a solid-wall portion adjacent to said first rotating cup and a fenestrated portion adjacent to said solid-wall portion, and
a well in said second rotating cup sufficiently wide to receive said fenestrated axial portion of said cylindrical extension.

7. Apparatus in accordance with claim 1 in which said means for positioning and simultaneously spinning said first and second rotating cups is a counter-rotating motor comprised of a rod shaft, a hollow cylindrical shaft encircling said rod shaft, and motor drives connected to cause said rod shaft and said hollow cylindrical shaft to rotate in opposite directions, said first rotating cup being affixed to said hollow cylindrical shaft and said second rotating cup being affixed to said rod shaft.

8. Apparatus in accordance with claim 1 in which said means for delivering said liquid coating material is a single conduit with two openings sufficiently spaced apart that when one said opening is positioned inside said first rotating cup the other said opening is positioned inside said second rotating cup.

9. Apparatus in accordance with claim 1 further comprising liquid joining means for combining two components of a liquid coating material, and static mixing means for mixing said combined components upstream of said means for delivering said liquid coating material to said first and second rotating cups.
